(19) United States
(12) Patent Application Publication
(10) Pub. No.: US 2026/0309844 A1
(43) Pub. Date: Oct. 8, 2026

(54) METHOD OF OBJECT DETECTION AND OBJECT STATUS IDENTIFICATION AND RELATED ELECTRONIC DEVICE

(71) Applicant: RichWave Technology Corp., Taipei City (TW)

(72) Inventor: Tse-Peng Chen, Taipel City (TW)

(73) Assignee: RichWave Technology Corp., Taipei City (TW)

(21) Appl. No.: 19/198,131

(22) Filed: May 5, 2025

Related U.S. Application Data
(60) Provisional application No. 63/642,874, filed on May 5, 2024.

(30) Foreign Application Priority Data
May 5, 2025 (TW) 114116693

(51) Int. Cl. G01S 7/41; G01S 13/931

(52) U.S. Cl. CPC G01S 7/415; G01S 13/931

(57) ABSTRACT

An electronic device includes a radar and an analyzing control circuit for performing object detection and object status identification. First, the radar performs first radar detection in a moving state in order to detect an object. After the analyzing control circuit determines that the object is detected based on the result of the first radar detection, the radar stops moving and starts to perform second radar detection in an immobile state for identifying the status of the detected object. Based on the status of the detected object, the analyzing control circuit controls the electronic device to perform corresponding action.

### CROSS REFERENCE TO RELATED APPLICATION

This application claims the benefit of U.S. Provisional Application No. 63/642,874, filed on May 5, 2024. The content of the application is incorporated herein by reference.

### TECHNICAL FIELD

The present invention is related to a method of object detection and object status identification and related electronic device, and more particularly, to a method of performing object detection using radar in moving state and performing object status identification using radar in immobile state and related electronic device.

### BACKGROUND

With the development of technology, robotic devices have become more common for performing various tasks in a semi-autonomous or autonomous manner. This type of robotic device may be implemented in various forms and used in a variety of applications, such as autonomous vacuum cleaners, unmanned aerial vehicles, and ground vehicles, etc. Robot applications include recreational applications (e.g., robot toys), practical applications in hostile environments (e.g., space, deep water, cryogenics, radiation, chemical exposure, biohazards, etc.), hazardous tasks (e.g., defusing explosives, search and rescue operations), or performing trivial tasks in confined spaces (e.g., cleaning robots).

Since most of the application environment is not static, radar and positioning systems are often deployed within robotic devices for providing a high degree of autonomy. Therefore, how to accurately detect the position and motion changes of obstacles in the environment is an important topic in robot applications.

### SUMMARY

The present invention provides a method of object detection and object status identification. First, an electronic device performing a first radar detection in a moving state by sequentially transmitting wireless signals at a first to an N^{th} time points in order to correspondingly obtain a first to an N^{th} moving-state radar echo signals; and determining whether an object is detected based on at least one of the first to the N^{th} moving-state radar echo signals, wherein N is an integer greater than 1. In response to determining that the object is detected, the electronic device stopping moving in order to perform a second radar detection in an immobile state by sequentially transmitting wireless signals at a first to an M^{th} time points in order to correspondingly obtain a first to an M^{th} immobile-state radar echo signals, and identifying a status of the object based on at least one of the first to the M^{th} immobile-state radar echo signals, wherein the status of the object includes a static state or a dynamic state, and M is an integer greater than 1.

The present invention also provides an electronic device for performing object detection and object status identification. The electronic device includes a movable body, a radar, and an analyzing control circuit. The radar is disposed on the movable body and configured to perform a first radar detection in a moving state by sequentially transmitting wireless signals at a first to an N^{th} time points in order to correspondingly obtain a first to an N^{th} moving-state radar echo signals; and perform a second radar detection in an immobile state by sequentially transmitting wireless signals at a first to an M^{th} time points in order to correspondingly obtain a first to an M^{th} immobile-state radar echo signals. The analyzing control circuit, configured to determine whether an object is detected based on at least one of the first to the N^{th} moving-state radar echo signals; and identify a status of the object based on at least one of the first to the M^{th} immobile-state radar echo signals, wherein M and N are integers greater than 1, and the status of the detected object includes a static state or a dynamic state.

### BRIEF DESCRIPTION OF THE DRAWINGS

FIG. 1 is a functional diagram illustrating an electronic device capable of performing object detection and object status identification according to an embodiment of the present application.

FIG. 2 is a diagram illustrating an implementation of the electronic device capable of performing object detection and object status identification according to an embodiment of the present application.

FIG. 3 is a flowchart illustrating the operation of the electronic device when performing object detection and object status identification according to an embodiment of the present application.

FIGS. 4-7 are radar range spectrum diagrams illustrating the operation of the electronic device when performing object status identification according to an embodiment of the present invention.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

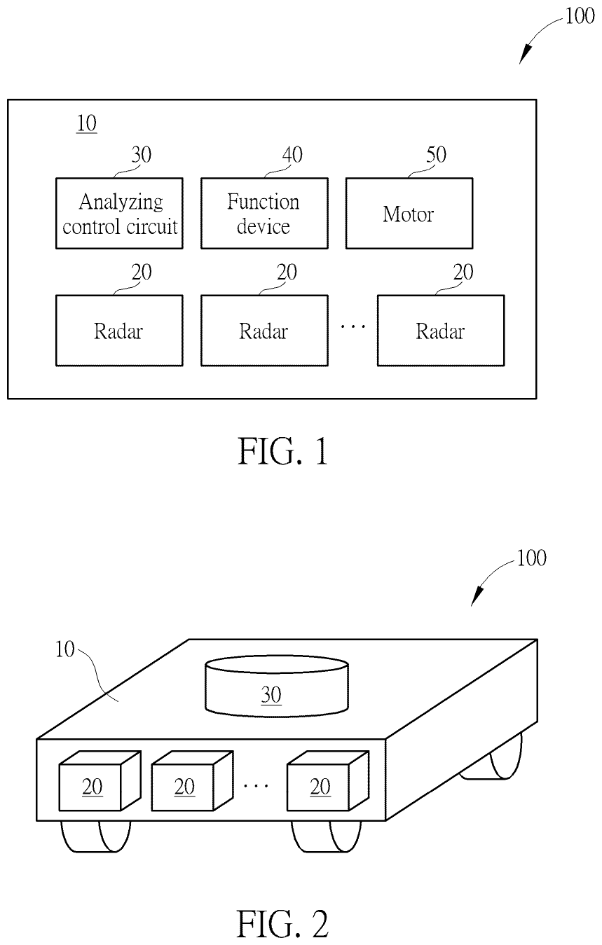

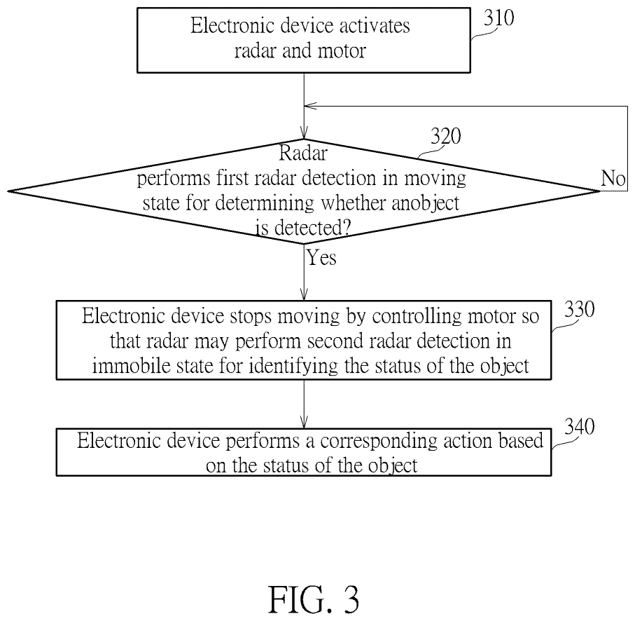

FIG. 1 is a functional diagram illustrating an electronic device 100 capable of performing object detection and object status identification according to an embodiment of the present application. FIG. 2 is a diagram illustrating an implementation of the electronic device 100 capable of performing object detection and object status identification according to an embodiment of the present application. The electronic device 100 includes a movable body 10, one or multiple radars 20, an analyzing control circuit 30, a function device 40, and a motor 50. Each radar 20 is disposed on the movable body 10 and configured to perform first radar detection in a moving state and perform second radar detection in an immobile state. The analyzing control circuit 30 is disposed in the movable body 10 and configured to control the operation of the motor 50 so as to set the electronic device 100 in the moving state or in the immobile state and to control the direction/rotation of the electronic device 100 in the moving state. Meanwhile, the analyzing control circuit 30 is also configured to determine whether an object is detected based on the data acquired by the first radar detection, identify the status of the detected object based on the data acquired by the second radar detection, and control the operation of the function device 40 based on the status of the detected object.

In the present invention, each radar 20 may be a pulse radar, a frequency modulated continuous wave (FMCW) radar, or any suitable radar capable of detecting objects and distances. However, the type of the one or multiple radars 20 does not limit the scope of the present invention.

In an embodiment of the present invention, the electronic device 100 may be a robotic vacuum cleaner and the function device 40 may be a brush or a mop. In another embodiment of the present invention, the electronic device 100 may be a rescue robot and the function device 40 may be a mechanical arm. However, the type of the electronic device 100 does not limit the scope of the present invention.

In the embodiment depicted in FIG. 2, the movable body 10 of the electronic device 100 may include rollers or wheels driven by the motor 50 which is controlled by the analyzing control circuit 30. The direction/rotation of the electronic device 100 in the moving state may be controlled by adjusting the angle of the rollers/wheels. However, the moving mechanism of the electronic device 100 does not limit the scope of the present invention.

During the process when the electronic device 100 performs object detection and object status identification, each radar 20 serves two different roles: the radar 20 assuming a first role is configured to perform the first radar detection in the moving state in order to determine whether an object is detected, and the radar 20 assuming a second role is configured to perform the second radar detection in the immobile state in order to identify the status of the detected object.

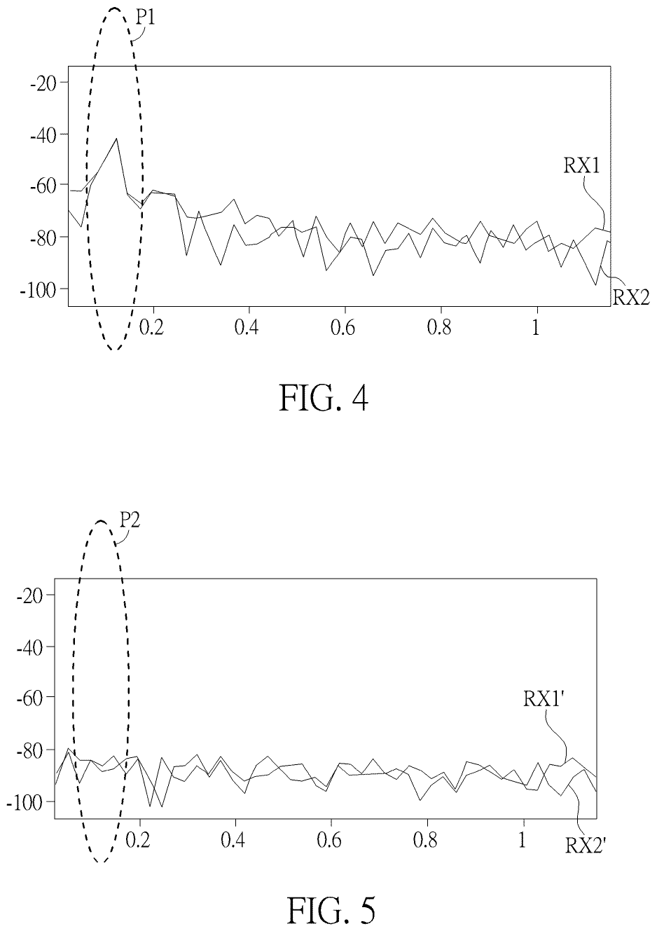

FIG. 3 is a flowchart illustrating the operation of the electronic device 100 when performing object detection and object status identification according to an embodiment of the present application. The flowchart of FIG. 3 includes the following steps:
Step 310: the electronic device 100 activates the radar 20 and the motor 50.
Step 320: the radar 20 performs the first radar detection in the moving state for determining whether an object is detected? If yes, execute step 330; if no, execute step 320.
Step 330: the electronic device 100 stops moving by controlling the motor 50 so that the radar 20 may perform the second radar detection in the immobile state for identifying the status of the object.
Step 340: the electronic device 100 performs a corresponding action based on the status of the object.

In step 310, after the analyzing control circuit 30 activates the radar 20 and the motor 50, the electronic device 100 may follow a predetermined path or move randomly in the moving state. In another embodiment, the electronic device 100 may further include a sensor or sensors of various types capable of scanning the environment for providing intelligent navigation on a real-time basis. However, the method of determining/adjusting the route of the electronic device 100 does not limit the scope of the present invention.

In step 310, the radar 20 performs the first radar detection in the moving state for determining whether an object is detected. First, the radar 20 is configured to sequentially transmit wireless signals at a first to an N^{th} time points in order to correspondingly obtain a first to an N^{th} moving-state radar echo signals, wherein N is an integer greater than 1. Next, the analyzing control circuit 30 is configured to determine whether an object is detected based on at least one of the first to the N^{th} moving-state radar echo signals. More specifically, the analyzing control circuit 30 is configured to acquire a first to an N^{th} moving-state radar range spectrum data respectively corresponding to the first to the N^{th} moving-state radar echo signals and determine whether the object is detected based on at least one of the first to the N^{th} moving-state radar range spectrum data. The radar range spectrum data includes the relationship between distance and energy. When represented in a two-dimensional radar range spectrum diagram, the horizontal axis represents the distance, and the vertical axis represents the energy of radar echo signals.

In an embodiment, the analyzing control circuit 30 is configured to determine whether the energy of the radar echo signal at a predetermined distance exceeds a moving-state threshold value based on at least one of the first to the N^{th} moving-state radar range spectrum data. When determining that the energy of the radar echo signal at the predetermined distance exceeds the move-state threshold value, the analyzing control circuit 30 determines that the object is detected.

In an embodiment, the analyzing control circuit 30 is configured to generate a moving-state discrepancy based on the N^{th} moving-state radar range spectrum data and a first reference moving-state radar range spectrum data in step 320, wherein the first reference moving-state radar range spectrum data is associated with at least one of the first to the (N−1)^{th} moving-state radar range spectrum data. When determining that the moving-state discrepancy exceeds a moving-state conditional range, the analyzing control circuit 30 determines that the object is detected.

In an embodiment, the analyzing control circuit 30 is configured to generate a plurality of moving-state discrepancies based on the N^{th} moving-state radar range spectrum data and the first reference moving-state radar range spectrum data at least during a specific time period in step 320. The analyzing control circuit 30 may determine whether the object is detected based on the plurality of moving-state discrepancies in order to reduce the misjudgment rate of object detection by lowering the interferences of unexpected echo signals in the environment.

In an embodiment, the moving-state conditional range may include an energy difference threshold value corresponding to a specific distance or an energy difference threshold group containing a plurality of energy difference threshold values respectively corresponding to a plurality of adjacent specific distances. The analyzing control circuit 30 may generate the moving-state discrepancy by subtracting the energy of the radar echo signal at a corresponding distance in the first reference moving-state radar range spectrum data from the energy of the radar echo signal at the corresponding distance in the N^{th} moving-state radar range spectrum data, or by dividing the energy of the radar echo signal at the corresponding distance in the N^{th} moving-state radar range spectrum data by the energy of the radar echo signal at the corresponding distance in the first reference moving-state radar range spectrum data. The moving-state discrepancy includes the relationship between distance and energy. When represented in a two-dimensional radar range spectrum diagram, the horizontal axis represents the distance, and the vertical axis represents the above-mentioned subtraction/division result from the N^{th} moving-state radar range spectrum data and the first reference moving-state radar range spectrum data. When determining that the moving-state discrepancy at a predetermined distance exceeds the energy difference threshold value or that the plurality of move-state discrepancies at the plurality of adjacent specific distances exceed corresponding energy difference threshold values in the energy difference threshold group, the analyzing control circuit 30 determines that the moving-state discrepancy exceeds the moving-state conditional range.

In an embodiment, the first reference moving-state radar range spectrum data may be the piece of data prior to the N^{th} moving-state radar range spectrum data, i.e., the (N−1)^{th} moving-state radar range spectrum data. In another embodiment, the first reference moving-state radar range spectrum data may be the average of multiple pieces of data prior to the N^{th} moving-state radar range spectrum data, i.e., the average of the (N−1−L)^{th} to the (N−1)^{th} moving-state radar range spectrum data, wherein L is an integer greater than 0 and smaller than N−1.

In an embodiment, the first reference moving-state radar range spectrum data may be used to compensate the impact of the radar movement. If most waveforms still exist after deducting the first reference moving-state radar range spectrum data from the N^{th} moving-state radar range spectrum data (which means the signals in the first to the N^{th} moving-state radar range spectrum data may mainly be related to the object), the moving-state discrepancy exceeds the moving-state conditional range, and the analyzing control circuit 30 determines that the object is detected. If all/most waveforms disappear after deducting the first reference moving-state radar range spectrum data from the N^{th} moving-state radar range spectrum data (which means the signals in the first to the N^{th} moving-state radar range spectrum data may mainly be caused by the movement of the radar 20), the moving-state discrepancy is within the moving-state conditional range, and the analyzing control circuit 30 determines that the object is not detected. In the present embodiment, deducting the first reference moving-state radar range spectrum data from the N^{th} moving-state radar range spectrum data may be achieved by: subtracting the first reference moving-state radar range spectrum data at each distance from the N^{th} moving-state radar range spectrum data at each corresponding distance, dividing the N^{th} moving-state radar range spectrum data at each distance by the first reference moving-state radar range spectrum data at each corresponding distance, or the combination of the above-mentioned two methods.

In an embodiment, when the radar 20 performs the first radar detection in the moving state in step 320, the analyzing control circuit 30 may further be configured to perform background removal on the moving-state radar range spectrum data at least during a predetermined period. For example, the first to the N^{th} moving-state radar range spectrum data include a first to an N^{th} frames of moving-state radar range spectrum diagram, respectively. At least during the predetermined period, the analyzing control circuit 30 is configured to continuously subtract a (P−1)^{th} frame of moving-state radar range spectrum diagram from a P^{th} frame of moving-state radar range spectrum diagram or divide the P^{th} frame of moving-state radar range spectrum diagram by the (P−1)^{th} frame of moving-state radar range spectrum diagram, wherein P is an integer between 2 and N. For example, the background removal can be performed on two consecutive frames. When the signal associated with the object is present in at least one frame of moving-state radar range spectrum diagram among the first to the N^{th} frames of moving-state radar range spectrum diagram after performing the background removal, the analyzing control circuit 30 determines that the object is detected. By performing subtraction/division on two consecutive frames of moving-state radar range spectrum diagram, the interferences from unexpected echo signals in the environment may be lowered, thereby largely reducing the misjudgment rate of object detection.

In an embodiment, when the radar 20 performs the first radar detection in the moving state in step 320, the analyzing control circuit 30 may further be configured to obtain at least one of a first to an N^{th} moving-state radar speed data corresponding to the first to the N^{th} moving-state radar echo signal and determine whether the object is detected based on at least one of the first to the N^{th} moving-state radar speed data. In an embodiment, the above-mentioned moving-state radar speed spectrum data may be associated with corresponding moving-state radar range spectrum data. The speed spectrum data includes the relationship between speed and energy. When represented in a two-dimensional radar speed spectrum diagram, the horizontal axis represents the speed, and the vertical axis represents the energy of the radar echo signal. In an embodiment, the radar speed spectrum data may be acquired by performing fast Fourier transform (FFT) or any suitable algorithm on the radar range spectrum data. In an embodiment, the analyzing control circuit 30 is configured to determine whether the energy of the radar echo signal at a predetermined speed exceeds a moving-state threshold value based on at least one of the first to the N^{th} moving-state radar speed data. When determining that the energy of the radar echo signal at the predetermined speed exceeds the moving-state threshold value, the analyzing control circuit 30 determines that the object is detected and that the detected object moves with this predetermined speed.

After the analyzing control circuit 30 determines that the object is detected in step 320, the electronic device 100 is configured to stop moving in step 330 so that the radar 20 may perform the second radar detection in the immobile state for identifying the status of the object. In an embodiment, when determining that the object is detected, the analyzing control circuit 30 is further configured to calculate the distance between the electronic device 100 and the object. When determining that the distance between the electronic device 100 and the object is smaller than a predetermined value, the analyzing control circuit 30 is configured to instruct the electronic device 100 to stop moving in step 330 so that the radar 20 may perform the second radar detection in the immobile state.

In step 330, at first the radar 20 in the immobile state is configured to sequentially transmit wireless signals at a first to an M^{th} time points in order to correspondingly obtain a first to an M^{th} immobile-state radar echo signals, wherein M is an integer greater than 1. Next, the analyzing control circuit 30 is configured to identify the status of the object based on at least one of the first to the M^{th} immobile-state radar echo signals, wherein the above-mentioned status includes a static state or a dynamic state. More specifically, the analyzing control circuit 30 is configured to obtain a first to an M^{th} immobile-state radar range spectrum data respectively corresponding to the first to the M^{th} immobile-state radar echo signals and identify the status of the object based on at least one of the first to the (M−1)^{th} immobile-state radar range spectrum data.

In an embodiment, the analyzing control circuit 30 is configured to generate an immobile-state discrepancy based on the M^{th} immobile-state radar range spectrum data and a reference immobile-state radar range spectrum data in step 330, wherein the reference immobile-state radar range spectrum data is associated with at least one of the first to the (M−1)^{th} immobile-state radar range spectrum data. When determining that the immobile-state discrepancy is within an immobile-state conditional range, the analyzing control circuit 30 identifies the status of the object as the static state; when determining that the immobile-state discrepancy exceeds the immobile-state conditional range, the analyzing control circuit 30 identifies the status of the object as the dynamic state.

In an embodiment, the analyzing control circuit 30 is configured to generate a plurality of immobile-state discrepancies based on the M^{th} immobile-state radar range spectrum data and the reference immobile-state radar range spectrum data at least during a specific time period in step 330. The analyzing control circuit 30 may perform object status identification based on the plurality of immobile-state discrepancies in order to reduce the misjudgment rate by lowering the interferences of unexpected echo signals in the environment.

In an embodiment, the immobile-state conditional range may include an energy difference threshold group corresponding to a plurality of adjacent specific distance ranges. The analyzing control circuit 30 may generate the immobile-state discrepancy by subtracting the energy of the radar echo signal at a corresponding distance in the reference immobile-state radar range spectrum data from the energy of the radar echo signal at the corresponding distance in the M^{th} immobile-state radar range spectrum data, or by dividing the energy of the radar echo signal at the corresponding distance in the M^{th} immobile-state radar range spectrum data by the energy of the radar echo signal at the corresponding distance in the reference immobile-state radar range spectrum data. The immobile-state discrepancy includes the relationship between distance and energy. When represented in a two-dimensional radar range spectrum diagram, the horizontal axis represents the distance, and the vertical axis represents the above-mentioned subtraction/division result from the M^{th} immobile-state radar range spectrum data and the reference immobile-state radar range spectrum data. When determining that the plurality of immobile-state discrepancies at a plurality of adjacent specific distances exceed corresponding threshold values in the energy difference threshold group, the analyzing control circuit 30 determines that the immobile-state discrepancy exceeds the immobile-state conditional range; otherwise, the analyzing control circuit 30 determines that the immobile-state discrepancy is within the immobile-state conditional range.

In an embodiment, the reference immobile-state radar range spectrum data may be the piece of data prior to the M^{th} immobile-state radar range spectrum data, i.e., the (M−1)^{th} immobile-state radar range spectrum data. In another embodiment, the reference immobile-state radar range spectrum data may be the average of multiple pieces of data prior to the M^{th} immobile-state radar range spectrum data, i.e., the average of the (M−1−L)^{th} to the (M−1)^{th} immobile-state radar range spectrum data, wherein L is an integer larger than 0 and smaller than M−1.

In an embodiment, the reference immobile-state radar range spectrum data may be used to compensate the impact of the radar movement. After the radar 20 in the moving state stops moving in response to detecting the object, if all/most waveforms disappear after deducting the reference immobile-state radar range spectrum data from the M^{th} immobile-state radar range spectrum data (which means the radar 20 in the immobile state does not detect any motion), the immobile-state discrepancy is within the immobile-state conditional range, and the analyzing control circuit 30 identifies the status of the object as the static state. After the radar 20 in the moving state stops moving in response to detecting the object, if all/most waveforms still exist after deducting the reference immobile-state radar range spectrum data from the M^{th} immobile-state radar range spectrum data (which means the signals in the first to the M^{th} immobile-state radar range spectrum data may mainly be caused by the movement of the object), the immobile-state discrepancy exceeds the immobile-state conditional range, and the analyzing control circuit 30 identifies the status of the object as the dynamic state. In the present embodiment, deducting the reference immobile-state radar range spectrum data from the M^{th} immobile-state radar range spectrum data may be achieved by: subtracting the reference immobile-state radar range spectrum data at each distance from the M^{th} immobile-state radar range spectrum data at each corresponding distance, dividing the M^{th} immobile-state radar range spectrum data at each distance by the reference immobile-state radar range spectrum data at each corresponding distance, or the combination of the above-mentioned two methods.

In an embodiment, when the radar 20 performs the second radar detection in the immobile state in step 330, the analyzing control circuit 30 may further be configured to obtain at least one of a first to an M^{th} immobile-state radar speed data corresponding to the first to the M^{th} immobile-state radar echo signals and identify the status of the object based on at least one of the first to the M^{th} immobile-state radar speed data. In an embodiment, the above-mentioned immobile-state radar speed spectrum data may be associated with corresponding immobile-state radar range spectrum data. In an embodiment, the analyzing control circuit 30 is configured to determine whether the energy of the radar echo signal at a predetermined speed exceeds an immobile-state threshold value based on at least one of the first to the M^{th} immobile-state radar speed data in step 330. When determining that the energy of the radar echo signal at the predetermined speed exceeds the immobile-state threshold value, the analyzing control circuit 30 identifies the object as a dynamic object moving with this predetermined speed.

In an embodiment, when the radar 20 performs the second radar detection in the immobile state in step 330, the analyzing control circuit 30 may further be configured to determine whether at least one of the first to the M^{th} immobile-state radar echo signals matches a predetermined characteristic after identifying the status of the object as the dynamic state based on at least one of the first to the M^{th} immobile-state radar echo signals. When determining that at least one of the first to the M^{th} immobile-state radar echo signals matches the predetermined characteristic (such as matching a first characteristic), the analyzing control circuit 30 determines that the object is a living creature. When determining that at least one of the first to the M^{th} immobile-state radar echo signals does not match the predetermined characteristic (such as not matching the first characteristic but matching a second characteristic), the analyzing control circuit 30 determines that the object is a non-living creature. In an embodiment, the predetermined characteristic may include the range spectrum characteristic and/or the speed characteristic of the first to the M^{th} immobile-state radar echo signals after being processed. For example, the first characteristic of a living creature may be low-frequency regular variations in waveforms (such as energy variations due to respiration); the second characteristic of a non-living creature may be high-frequency regular movement (such as the blade rotation of an electric fan in operation). In another embodiment, artificial intelligence (AI) may be adopted for identifying the characteristics of the first to the M^{th} immobile-state radar echo signals for determining the status of the object.

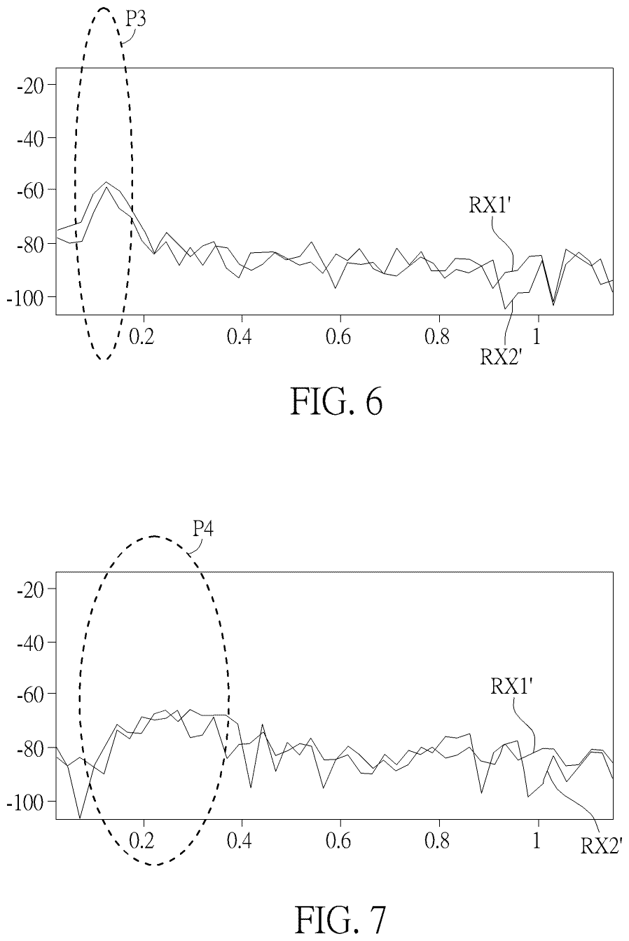

FIGS. 4-7 are radar range spectrum diagrams illustrating the operation of the electronic device 100 when performing object status identification according to embodiments of the present invention. For illustrative purpose, it is assumed that the electronic device 100 includes two radars 20, the horizontal axis represents distance (in meters), and the vertical axis represents the energy of the radar echo signals (in dBFS). FIG. 4 depicts at least a moving-state radar echo signal RX1 and a moving-state radar echo signal RX2 acquired when the two radars 20 perform the first radar detection in the moving-state. FIGS. 5-7 depict at least an immobile-state radar echo signal RX1′ and an immobile-state radar echo signal RX2′ acquired when the two radars 20 perform the second radar detection in the immobile-state. Based on the above-mentioned step 320, when the two radars 20 perform the first radar detection in the moving state, it is assumed that the object is detected at a specific distance (such as at around 0.12 m as designated by P1), as depicted in FIG. 4.

In the embodiment depicted in FIG. 5, based on the above-mentioned step 330, when the two radars 20 perform the second radar detection in the immobile state, all/most waveforms disappear at a location corresponding to the specific distance (designated by P2) in the immobile-state radar echo signals RX1′ and RX2′, which means that the two radars 20 do not detect any motion in the immobile state. Under such circumstance, the analyzing control circuit 30 identifies the status of the object as the static state.

In the embodiments depicted in FIGS. 6 and 7, based on the above-mentioned step 330, when the two radars 20 perform the second radar detection in the immobile-state, most waveforms are still present at locations corresponding to the specific distance (designated by P3 and P4) in the immobile-state radar echo signals RX1′ and RX2′, which means that the two radars 20 still detect motion in the immobile state. Under such circumstance, the analyzing control circuit 30 identifies the status of the object as the dynamic state.

In the embodiment depicted in FIG. 6, based on the above-mentioned step 340, after identifying the object as a dynamic object, the analyzing control circuit 30 is further configured to determine whether at least one immobile-state radar echo signal matches any predetermined characteristic. If at least one of the immobile-state radar echo signals RX1′ and RX2 matches the first characteristic of respiration, the analyzing control circuit 30 determines that the object is a living creature.

In the embodiment depicted in FIG. 7, based on the above-mentioned step 340, after identifying the object as a dynamic object, the analyzing control circuit 30 is further configured to determine whether at least one immobile-state radar echo signal matches any predetermined characteristic. If at least one of the immobile-state radar echo signals RX1′ and RX2 matches the second characteristic of machine in action, the analyzing control circuit 30 determines that the object is a non-living creature.

FIGS. 4-7 depict the waveforms of the moving-state radar echo signals RX1-RX2 and the immobile-state radar echo signals RX1′-RX2′ for illustrative purpose. In an embodiment, the present invention may perform object status identification based on one of the moving-state radar echo signals RX1-RX2 and one of the immobile-state radar echo signals RX1′-RX2′. In another embodiment, the present invention may perform object status identification based on the moving-state radar echo signals RX1-RX2 and the immobile-state radar echo signals RX1′-RX2′, thereby improving the accuracy and reliability of object status identification and providing more spatial information (such as the orientation of the object).

In step 340, the analyzing control circuit 30 is configured to instruct the electronic device 100 to perform the corresponding action based on the status of the object. More specifically, when determining that the object is static, the analyzing control circuit 30 instructs the electronic device 100 to perform a first action; when determining that the object is a dynamic living creature, the analyzing control circuit 30 instructs the electronic device 100 to perform a second action; when determining that the object is a dynamic non-living creature, the analyzing control circuit 30 instructs the electronic device 100 to perform a third action, wherein at least two of these three actions are different.

In the embodiment when the electronic device 100 is a robotic vacuum cleaner and the function device 40 is a brush or a mop, the first action may include controlling the function device 40 to clean the detected static object (such as a table leg) and the electronic device 100 changing its moving direction. The second action may include controlling the function device 40 to perform obstacle avoidance on the detected dynamic living creature (such as a pet or a human leg). The third action may include controlling the function device 40 to perform obstacle avoidance on the detected dynamic non-living creature (such as an electric fan in action).

In the embodiment when the electronic device 100 is a recue robot and the function device 40 is a mechanic arm, the first action may include controlling the function device 40 to clear the detected static object (such as broken furniture, wood or bricks in a disaster scene) from its path. The second action may include controlling the function device 40 to dispatch food, water and emergency supplies to the detected dynamic living creature (such as a wounded person) and/or sending an SOS signal. The third action may include controlling the function device 40 to perform obstacle avoidance on the detected dynamic non-living creature (such as an unknown hazardous item) and/or sending an alarm signal.

In conclusion, the present invention provide a method of object detection and object status identification method and a related electronic device. The radar 20 may perform first radar detection in the moving state for performing object detection and stops moving after detecting an object. The radar 20 may then perform second radar detection in the immobile state for performing object status identification. acquire at least one of a first to an M^{th} immobile-state radar speed data corresponding to the first to the M^{th} immobile-state radar range spectrum data and identify the status of the object based on at least one of the first to the M^{th} immobile-state radar speed data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of object detection and object status identification, comprising:
an electronic device performing a first radar detection in a moving state by:
sequentially transmitting wireless signals at a first to an N^{th} time points in order to correspondingly obtain a first to an N^{th} moving-state radar echo signals; and
determining whether an object is detected based on at least one of the first to the N^{th} moving-state radar echo signals, wherein N is an integer greater than 1; and
in response to determining that the object is detected, the electronic device stopping moving in order to perform a second radar detection in an immobile state by:
sequentially transmitting wireless signals at a first to an M^{th} time points in order to correspondingly obtain a first to an M^{th} immobile-state radar echo signals; and
identifying a status of the object based on at least one of the first to the M^{th} immobile-state radar echo signals, wherein the status of the object includes a static state or a dynamic state, and M is an integer greater than 1.

2. The method of claim 1, wherein identifying the status of the object based on at least one of the first to the M^{th} immobile-state radar echo signals further comprises:
obtaining a first to an M^{th} immobile-state radar range spectrum data corresponding to the first to the M^{th} immobile-state radar echo signals, respectively; and
identifying the status of the object based on at least one of the first to an (M−1)^{th} immobile-state radar range spectrum data.

3. The method of claim 2, wherein identifying the status of the object based on at least one of the first to the M^{th} immobile-state radar echo signals further comprises:
obtaining an immobile-state discrepancy based on the M^{th} immobile-state radar range spectrum data and a reference immobile-state radar range spectrum data which is associated with at least one of the first to the (M−1)^{th} immobile-state radar range spectrum data;
identifying the status of the object as the static state after determining that the immobile-state discrepancy is within an immobile-state conditional range; and
identifying the status of the detected object as the dynamic state after determining that the immobile-state discrepancy is not within the immobile-state conditional range.

4. The method of claim 3, wherein:
the reference immobile-state radar range spectrum data is the (M−1)^{th} immobile-state radar range spectrum data or an average of the (M−1−L)^{th} to the (M−1)^{th} immobile-state radar range spectrum data; and
L is an integer greater than 0 and smaller than M−1.

5. The method of claim 1, wherein identifying the status of the object based on at least one of the first to the M^{th} immobile-state radar echo signals further comprises:
obtaining at least one of a first to an M^{th} immobile-state radar speed data corresponding to the first to the M^{th} immobile-state radar range spectrum data, respectively; and
identifying the status of the object based on at least one of the first to the M^{th} immobile-state radar speed data.

6. The method of claim 1, wherein determining whether the object is detected based on at least one of the first to the N^{th} moving-state radar echo signals further comprises:
obtaining a first to an N^{th} moving-state radar range spectrum data corresponding to the first to the N^{th} moving-state radar echo signals, respectively; and
determining whether the object is detected based on at least one of the first to the N^{th} moving-state radar range spectrum data.

7. The method of claim 6, wherein determining whether the object is detected based on at least one of the first to the N^{th} moving-state radar echo signals further comprises:
obtaining a moving-state discrepancy based on the N^{th} moving-state radar range spectrum data and a first reference moving-state radar range spectrum data which is associated with at least one of the first to the (N−1)^{th} moving-state radar range spectrum data; and
determining that the object is detected after determining that the moving-state discrepancy exceeds a moving-state conditional range.

8. The method of claim 7, wherein:
the first reference moving-state radar range spectrum data is the (N−1)^{th} moving-state radar range spectrum data or an average of the (N−1−L)^{th} to the (N−1)^{th} moving-state radar range spectrum data; and
L is an integer greater than 0 and smaller than N−1.

9. The method of claim 1, wherein determining whether the object is detected based on at least one of the first to the N^{th} moving-state radar echo signals further comprises:
obtaining at least one of a first to an N^{th} moving-state radar speed data corresponding to the first to the N^{th} moving-state radar echo signals, respectively; and
determining whether the object is detected based on at least one of the first to the N^{th} moving-state radar speed data.

10. The method of claim 1, wherein the electronic device stopping moving in order to perform the second radar detection in the immobile state in response to determining that the object is detected further comprises:
calculating a distance between the electronic device and the object after determining that the object is detected; and
the electronic device stopping moving in order to perform the second radar detection in the immobile state after determining that the distance between the electronic device and the object is smaller than a predetermined value.

11. The method of claim 1, further comprising:
determining whether at least one of the first to the M^{th} immobile-state radar range spectrum data matches a predetermined characteristic after identifying the status of the detected object as the dynamic state based on at least one of the first to the M^{th} immobile-state radar echo signals;
determining that the object is a living creature when at least one of the first to the M^{th} immobile-state radar range spectrum data matches the predetermined characteristic; and
determining that the object is a non-living creature when at least one of the first to the M^{th} immobile-state radar range spectrum data does not match the predetermined characteristic.

12. The method of claim 11, further comprising:
the electronic device performing a first action after identifying the status of the detected object as the static state;
the electronic device performing a second action after identifying the status of the detected object as the dynamic state and determining that the object is the living creature; and
the electronic device performing a third action after identifying the status of the detected object as the dynamic state and determining that the object is the non-living creature, wherein the first to the third actions include at least two different actions.

13. The method of claim 1, wherein determining whether the object is detected based on at least one of the first to the N^{th} moving-state radar echo signals further comprises:
obtaining a first to an N^{th} moving-state radar range spectrum data corresponding to the first to the N^{th} moving-state radar echo signals, respectively, wherein the first to the N^{th} moving-state radar range spectrum data include a first to an N^{th} frames of moving-state radar range spectrum diagram;
performing a background removal by continuously subtracting a (P−1)^{th} frame of moving-state radar range spectrum diagram from a P^{th} frame of moving-state radar range spectrum diagram or dividing the P^{th} frame of moving-state radar range spectrum diagram by the (P−1)^{th} frame of moving-state radar range spectrum diagram at least during a predetermined period, wherein P is an integer between 2 and N; and
determining that the object is detected when a signal associated with the object is present in at least one frame of moving-state radar range spectrum diagram among the first to the N^{th} frames of moving-state radar range spectrum diagram after performing the background removal.

14. An electronic device for performing object detection and object status identification, comprising:
a movable body;
a radar disposed on the movable body and configured to:
perform a first radar detection in a moving state by sequentially transmitting wireless signals at a first to an N^{th} time points in order to correspondingly obtain a first to an N^{th} moving-state radar echo signals; and
perform a second radar detection in an immobile state by sequentially transmitting wireless signals at a first to an M^{th} time points in order to correspondingly obtain a first to an M^{th} immobile-state radar echo signals; and
an analyzing control circuit, configured to:
determine whether an object is detected based on at least one of the first to the N^{th} moving-state radar echo signals; and
identify a status of the object based on at least one of the first to the M^{th} immobile-state radar echo signals, wherein:
M and N are integers greater than 1; and
the status of the detected object includes a static state or a dynamic state.

15. The electronic device of claim 14, wherein the analyzing control circuit is further configured to:
obtain a first to an M^{th} immobile-state radar range spectrum data corresponding to the first to the M^{th} immobile-state radar echo signals, respectively;
obtain an immobile-state discrepancy based on the M^{th} immobile-state radar range spectrum data and a reference immobile-state radar range spectrum data, wherein the reference immobile-state radar range spectrum data is the (M−1)^{th} immobile-state radar range spectrum data or an average of the (M−1−L)^{th} to the (M−1)^{th} immobile-state radar range spectrum data, and L is an integer greater than 0 and smaller than M−1;
identify the status of the object as the static state after determining that the immobile-state discrepancy is within an immobile-state conditional range; and
identify the status of the detected object as the dynamic state after determining that the immobile-state discrepancy is not within the immobile-state conditional range.

16. The electronic device of claim 14, wherein the analyzing control circuit is further configured to:
obtain a first to an N^{th} moving-state radar range spectrum data corresponding to the first to the N^{th} moving-state radar echo signals, respectively;
obtain a moving-state discrepancy based on the N^{th} moving-state radar range spectrum data and a first reference moving-state radar range spectrum data, wherein the first reference moving-state radar range spectrum data is the (N−1)^{th} moving-state radar range spectrum data or an average of the (N−1−L)^{th} to the (N−1)^{th} moving-state radar range spectrum data, and L is an integer greater than 0 and smaller than N−1; and
determine that the object is detected after determining that the moving-state discrepancy exceeds a moving-state conditional range.

17. The electronic device of claim 14, wherein the analyzing control circuit is further configured to:
obtain at least one of a first to an N^{th} moving-state radar range spectrum data corresponding to the first to the N^{th} moving-state radar echo signals, respectively;
obtain at least one of a first to an M^{th} immobile-state radar range spectrum data a corresponding to the first to the M^{th} immobile-state radar echo signals, respectively;
determine whether a signal associated with the object in a second reference moving-state radar range spectrum data is present in at least one of the first to the M^{th} immobile-state radar range spectrum data, wherein the second reference moving-state radar range spectrum data is the N^{th} moving-state radar range spectrum data or an average of the (N−L)^{th} to the N^{th} moving-state radar range spectrum data, and L is an integer greater than 0 and smaller than N;
identify the status of the detected object as the dynamic state after determining that the signal associated the object in the second reference moving-state radar range spectrum data is also present in at least one of the first to the M^{th} immobile-state radar range spectrum data; and
identify the status of the detected object as the static state after determining that the signal associated the object in the second reference moving-state radar range spectrum data is not present in any of the first to the M^{th} immobile-state radar range spectrum data.

18. The electronic device of claim 14, wherein the analyzing control circuit is further configured to:
determining whether at least one of the first to the M^{th} immobile-state radar range spectrum data matches a predetermined characteristic after identifying the status of the detected object as the dynamic state based on at least one of the first to the M^{th} immobile-state radar echo signals;
determining that the object is a living creature when at least one of the first to the M^{th} immobile-state radar range spectrum data matches the predetermined characteristic;
determining that the object is a non-living creature when at least one of the first to the M^{th} immobile-state radar range spectrum data does not match the predetermined characteristic;
indicating the electronic device to perform a first action after identifying the status of the detected object as the static state;
indicating the electronic device to perform a second action after identifying the status of the detected object as the dynamic state and determining that the object is the living creature; and
indicating the electronic device to perform a third action after identifying the status of the detected object as the dynamic state and determining that the object is the non-living creature, wherein the first to the third actions include at least two different actions.

19. The electronic device of claim 14, wherein the analyzing control circuit is further configured to:
obtaining a first to an N^{th} moving-state radar range spectrum data corresponding to the first to the N^{th} moving-state radar echo signals, respectively, wherein the first to the N^{th} moving-state radar range spectrum data include a first to an N^{th} frames of moving-state radar range spectrum diagram;
performing a background removal by continuously subtracting a (P−1)^{th} frame of moving-state radar range spectrum diagram from a P^{th} frame of moving-state radar range spectrum diagram or dividing the P^{th} frame of moving-state radar range spectrum diagram by the (P−1)^{th} frame of moving-state radar range spectrum diagram at least during a predetermined period, wherein P is an integer between 2 and N; and
determining that the object is detected when a signal associated with the object is present in at least one frame of moving-state radar range spectrum diagram among the first to the N^{th} frames of moving-state radar range spectrum diagram after performing the background removal.

20. The electronic device of claim 14, wherein the analyzing control circuit is further configured to:
obtaining at least one of a first to an N^{th} moving-state radar speed data corresponding to the first to the N^{th} moving-state radar echo signals, respectively;
determining whether the object is detected based on at least one of the first to the N^{th} moving-state radar speed data;
calculating a distance between the electronic device and the object after determining that the object is detected; and
the electronic device stopping moving in order to perform the second radar detection in the immobile state after determining that the distance between the electronic device and the object is smaller than a predetermined value.
